(19) United States
(12) Patent Application Publication
(10) Pub. No.: US 2009/0015678 A1
(43) Pub. Date: Jan. 15, 2009

(54) METHOD AND SYSTEM FOR AUTOMATIC POSE AND TRAJECTORY TRACKING IN VIDEO

(76) Inventors: Anthony J. Hoogs, Niskayuna, NY (US); Nils Oliver Krahnstoever, Schenectady, NY (US); A. G. Perera, Clifton Park, NY (US); Xiaoming Liu, Schenectady, NY (US); Peter Tu, Niskayuna, NY (US); Gianfranco Doretto, Albany, NY (US)

Correspondence Address: BUCKLEY, MASCHOFF & TALWALKAR, LLC;GENERAL ELECTRIC COMPANY, 50 LOCUST AVENUE, NEW CANAAN, CT, 06840, US

(21) Appl. No.: 11/774,958

(22) Filed: Jul. 9, 2007

(51) Int. Cl. H04N 5/225; H04N 5/44

(52) U.S. Cl. 348/207.1; 348/559; 348/E05.107; 348/E05.024

(57) ABSTRACT

A system and method, the method including stabilizing a video sequence captured by an image capturing system, extracting a subject of interest in the stabilized video sequence to isolate the subject from other objects in the video sequence, determining a trajectory associated with the subject, tracking the trajectory of the subject over a period of time; extracting data associated with the trajectory of the subject based on the tracking; and presenting the extracted data in a user-understandable format.

### BACKGROUND

The present disclosure generally relates to a system and method for identifying objects in a video, and more particularly to a method and system of extracting and presenting data associated with an object of interest in a video sequence.

A number of video effects have been proposed and implemented in the past to augment a video presentation. Some examples of the video effects used to add or alter the information conveyed by a sequence of video images (i.e., a video sequence) include virtual effects such as markers to indicate a primarily fixed location (e.g., line of scrimmage in a football game) and annotations associated with a location (e.g., impact location of a javelin thro). In some conventional contexts, the location of a moving object has been tracked using a marker that is attached to the moving object. The marker may include a global positioning system (gps) device, an radio frequency identification (rfid) device, a specific pattern, color, or other trackable or identifiable item affixed to the object. Additionally, the moving object is usually constrained to isolated objects that move within a limited and predictable field of motion with limited dynamics.

Such constrained contexts of operation have often precluded or at least limited the effectiveness and applicability of visual effects involving video of multiple subjects performing complex motions, such as varied articulations.

Accordingly, there exist a need to provide a system and method of tracking motion parameters, including pose and trajectory, of subjects in a video sequence and presenting data associated with the motion parameters.

### SUMMARY

In some embodiments, a method includes stabilizing a video sequence captured by an image capturing system, extracting a subject of interest in the stabilized video sequence to isolate the subject from other objects in the video sequence, and determining a trajectory associated with the subject. The method may further include tracking the trajectory of the subject over a period of time, extracting data associated with the trajectory of the subject based on the tracking, and presenting the extracted data in a user-understandable format.

In some embodiments, a system including the image capturing device and a processor may be provided to implement the methods disclosed herein.

In some embodiments, the trajectory of the subject may be determined in two dimensions or three dimensions. The parameters of the trajectory may be, at least in part, related to a capability of the image capturing system.

In some embodiments, a pose of the subject may also be determined and tracked, according to a method and system herein. The pose of the subject in the video sequence may be tracked over a period of time. A presentation of the pose and/or the trajectory may be presented to a user in a user-understandable format. The user-understandable format may include a variety of formats such as, for example, one or more of an image, video, graphics, text, and audio.

### BRIEF DESCRIPTION OF THE DRAWINGS

FIG. 1 is an illustrative schematic diagram of a system, according to some embodiments herein;

FIG. 2 provides an illustrative flow diagram of a process, in accordance with some embodiments herein;

FIG. 3 is an illustrative depiction of an image captured and enhanced, in accordance with some embodiments herein; and

FIG. 4 is an exemplary illustration of a display environment, including an image captured and enhanced, in accordance herewith.

### DETAILED DESCRIPTION

In some embodiments, methods and systems in accordance with the present disclosure may visually and, in some instances automatically, extract information from a live or a recorded broadcast sequence of video images (i. e., a video sequence). The extracted information may be associated with one of more subjects of interest captured in the video. In some instances, the extracted information may pertain to motion parameters for the subject, including a pose and trajectory of the subject. The extracted data may be further presented to a viewer or user of the data in a format and manner that is understood by the viewer and facilitates an enhanced viewing experience for the viewer.

Due, at least in part, to the information is being extracted or derived from the video image, the viewer is presented with more information than is available in the original video sequence in a format than may be more readily understood than the original video sequence. The extracted information may provide the foundation for a wide variety of generated statistics and visualizations.

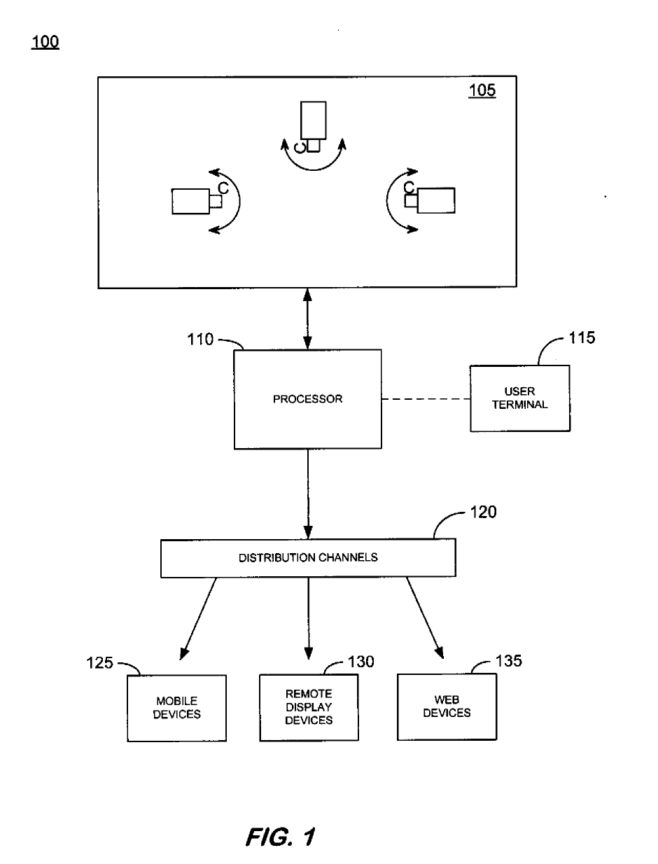

FIG. 1 is an illustrative depiction of a system, generally indicated by the reference number 100, that may be used in accordance with some embodiments herein. System 100 includes an image capturing system 105. Image capturing system 105 may include one or more image capture devices, such as camera devices 107. While one camera 107 may be sufficient to capture an event including a subject of interest, a plurality of camera devices may be used in order to capture the even from more than one perspective. In some embodiments, the use of a plurality of camera devices may facilitate in presenting a captured video sequence in three dimensions (i.e., 3-D).

In some embodiments, image capturing system 105 is capable of capturing video using analog techniques, while some other embodiments use at least some digital image capturing techniques. The analog techniques may use analog storage protocols and the digital techniques may use digital storage protocols. Camera devices 107 may be stationary or capable of being moved (manually or remotely controlled). Cameras 107 may also pan, tilt, and zoom in some instances.

Data captured by image capturing system 105 may be processed and manipulated by a processor 110, in accordance with methods herein. Processor 110 may be integrated with image capturing system 105 in some embodiments and distinct from image capturing system 105 in other embodiments. However, the functionality of the processor should at least include the functionality disclosed herein, including the functionality to implement various aspects of the systems and methods disclosed herein. Processor 110 may include a workstation, a PC, a server, a general purpose computing device, and a dedicated image processor. Processor 110 may be a consolidated or a distributed processing resource. Image capturing system 105 may forward captured images (e.g., video sequence) to processor 110. Processor 110 may forward control signals to image capturing system 105. Communication between image capturing system 105 and processor 110 may be established and/or used on an as-needed basis and may further be facilitated using a variety of presently known and future-known communication protocols. Various aspects of the types of processing accomplished by processor 110 will be further described in greater detail below.

In some embodiments, program instructions and code may be embodied in hardware and/or software, including known and future developed media, to implement the methods disclosed herein. In some embodiments, the program instructions and code may be executed by a processor such as that disclosed herein.

A user terminal 115 may be interfaced with system 100 to provide a mechanism for a user to control, observe, initialize, or maintain aspects of system 100. In some embodiments, user terminal 115 may be interfaced with processor 110 to control one or more aspects of the processor's operation. Communication between user terminal 115 and processor 110 may be wired, wireless, and combinations thereof using a variety of communication protocols.

Video processed in accordance with methods and operations herein may be distributed via a number of distribution channels 120 to a number and variety of mobile devices 125, remote display devices, and web-enabled devices 135.

It should be appreciated that the communication links between various component devices and subsystems of system 100 may be wired, wireless, permanent, ad-hoc, and selectively established in response to various events, demands, and desired outcomes.

It should also be appreciated that system 100 of FIG. 1 may include more, fewer, and substitute components and devices than those explicitly depicted therein.

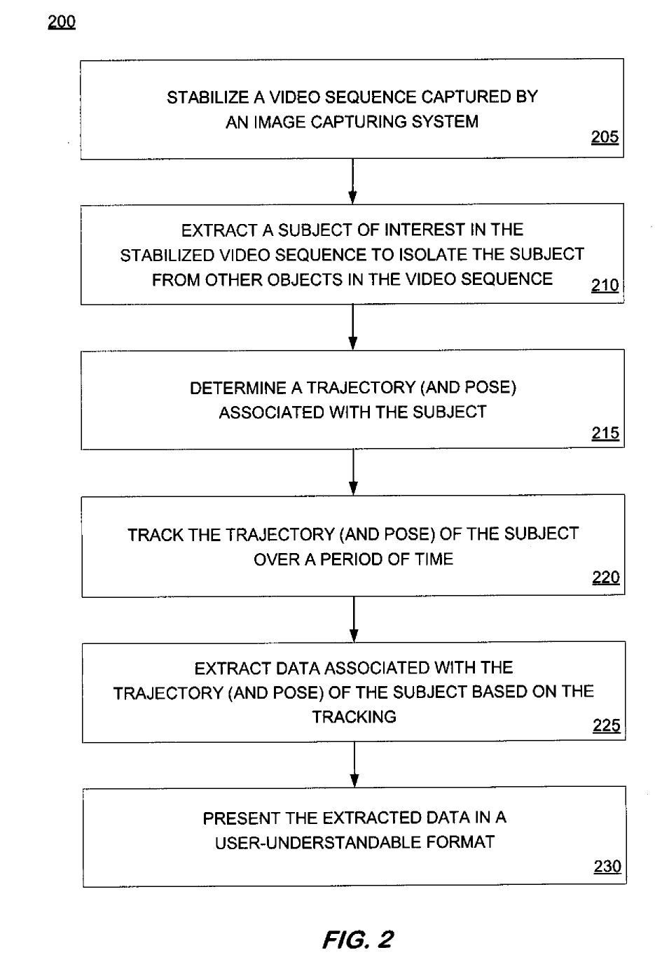

FIG. 2 is an illustrative flow diagram for a process 200, according to some embodiments herein. The sequence of video images or a video stream is captured by the image capturing system. The video sequence may be captured from multiple angles in the instances multiple camera devices located at more different locations are used to capture the video sequence simultaneously. At operation 205, a video sequence captured by an image capturing system is stabilized. Stabilizing the video involves video processes to compute image transforms that recreate the video sequence as if the camera device(s) were still. Movements of the camera(s) include pans, tilts, and zooming by the camera device, as well as changes in location of the camera device(s). Stabilization of the video sequence provides a stable, consistent frame of reference for further video processing of the video sequence. A desired result of the stabilization process of operation 205 is an accurate estimation of a correlation between real world, 3-dimensional (3D) coordinates and an image coordinate view of the camera(s) of the image capturing system.

In some embodiments, a calibration process of the image capturing devices may be used (not shown). The calibration may be manual, automatic, or a combination thereof. The image capturing systems herein may include a single camera device. However, in a number of embodiments the image capturing systems herein may include multiple camera devices. The camera device(s) may be stationary or movable. In addition to an overall stationary or ambulatory status of the camera device, the camera device(s) may have an ability to pan/tilt/zoom. Thus, even a stationary camera device(s) may be subject to a pan/tilt/zoom movement.

In an effort to accurately correlate an image captured by the image capturing system with the real-world in which the image capturing system and images captured thereby exist, the image capturing system may be calibrated. The calibration of the image capturing system may include an internal calibration wherein a camera device and other components of the image capturing system are calibrated relative to parameters and characteristics of the image capturing system. Further, the image capturing system may be externally calibrated to provide an estimation or determination of a relative location and pose of camera device(s) of the image capturing system with regards to a world-centric coordinate framework.

In some embodiments, the stabilization process of operation 205 or an image capturing system calibration process may include the acquisition, determination, or at least the use of certain knowledge information of the location of the image capturing system. For example, in an instance the image capturing system is deployed at a sporting event, the stabilization process may include learning and/or determining the boundaries of the arena, field, field of play, or parts thereof. In this manner, knowledge of the extent of a field of play, arena, boundaries, goals, ramps, and other fixtures of the sporting event may be used in other processing operations. Use of known information may, in some instances, be used to estimate certain aspects of the stabilization operation.

At operation 210, a process to extract a subject of interest in the captured video is performed to facilitate isolating the subject from other objects in the video sequence. The process of extracting the subject may be based, in part, on the knowledge or information obtained or used in the stabilization operation 205 or the calibration process. In some embodiments, such as the context of a sporting event, known characteristics of the field such as the location of the playing surface relative to camera, the boundaries of the field, an expected range of motion for the players in the arena (as compared to non-players) may be used in the detection and determination of the subject of interest. The subject of interest, in some embodiments herein, may be one individual among a multitude of individuals in an event of the video sequence.

In some embodiments, a further difficulty may be encountered in that the subject of interest may be in close proximity with other subjects and objects. In some embodiments, the particular subject of interest may be in close proximity with other subjects of similar size, shape, and/or orientation. In these and other instances, operation 210 provides a mechanism for isolating the subject of interest from the other objects and subjects. In some aspects, extracting operation 210 provides a crowd segmentation process to separate and isolate the subject of interest from a “crowd” of other objects and subjects.

In some embodiments, the subject(s) of interest may be detected by determining objects in the foreground of the captured video by a process such as, for example, foreground-background subtraction. Detection processes that involve determining objects in the foreground may be used in some embodiments herein, particularly where the subject of interest has a tendency to move relative to a background environment. The subject detection process may further include processing using a detection algorithm. The detection algorithm may use information obtained during the stabilization process 205, and image information associated with the foreground processing to detect the subject of interest.

It should be appreciated that other techniques and processes to detect the subjects of interest in the captured video and compatible with other aspects of the present disclosure may be used in operation 210. Some examples of processes to extract the subject of interest may include frame differencing wherein pixel-wise differences are computed between frames to determine which pixel are stationary and which pixels are not stationary. A point track analysis technique may be used that includes tracking feature points over a period of time in the video sequence and analyzing a trajectory of the feature points to determine which feature points are stationary. It should be appreciated that these and other techniques, processes, and operations may be used to extract the subject(s) of interest from the video sequence.

At operation 215, a trajectory for the subject that has been visually extracted from the background and other objects in the captured video sequence, is determined. The determination of the trajectory of the subject may include the use of a variety of techniques, processes, and operations.

At operation 220, the trajectory of the subject extracted from the video sequence is tracked over a period of time. That is, trajectory information associated with the subject of interest is determined for the subject for a number of successive or at least key frames of the captured video sequence. Tracking the trajectory of a subject may include or use one or more techniques, processes, and operations. Examples of some applicable techniques, at least in some embodiments, include analyzing an overall shape of the subject of interest or tracking certain parts of the subject. Regarding analyzing the overall shape of the subject, a centroid and principle axis, for example, may be used to yield a rotation of the subject (e.g., an athlete in the video sequence). Regarding tracking certain parts of the subject, the feet, hips, hands, torso, or head of a subject captured in the video sequence may be tracked over a portion of the video sequence to determine an accurate articulated model of the subject.

In some embodiments, tracking of the trajectory of the subject may be accomplished automatically by a machine (e.g., processor). In some embodiments, at least an initialization of the trajectory tracking may be used in accordance with some embodiments herein. For example, an operator may manually indicate the subject or part of the subject that is to be tracked in determining the trajectory of the subject. After the initialization process, the subsequent tracking of the subject's trajectory may be performed automatically by a machine.

The trajectory data provides an indication of the location of the subject of interest. In some embodiments, the trajectory data associated with the subject of interest may be estimated or determined using geometrical knowledge of the image capturing system and the captured video that is obtained or learned by the image capturing system or available to the image capturing system.

In some embodiments, trajectory data associated with the subject over a period of time may use fewer than each and every successive image of the captured video. For example, the tracking aspects herein may use a subset or “key” images of the captured video (e.g., 50% of the captured video).

Tracking operation 220 may include or use a process of conditioning or filtering the trajectory data associated with the subject to provide, for example, a smooth, stable, or normalized version of the trajectory data.

In some embodiments, pose determination and tracking operation(s) may be used to determine and track a pose or directional orientation of the subject. The pose determination and tracking operation(s) may be part of operations 215 and 220. That is, pose determination and tracking may be addressed and accomplished as part of operations 215 and 220. In some embodiments, pose determination and tracking operation(s) may be addressed and accomplished separately from operations 215 and 220.

At operation 225, a data extracting process extracts data associated with the trajectory data. The extracted data may include determining or deriving a height, a maximum speed, instant velocity, a direction of motion, pose (orientation), an acceleration, an average acceleration, a total distance traveled, a height jumped, a hang time calculation, and other parameters related to the subject of interest. For example, in the context of a sporting event, the extracted data my provide, based on the visual detection and tracking of the subject of interest as disclosed herein, the height, pose, velocity, and total height jumped by a high jumper, a diver, a stunt bike rider, a specific play or, a skateboard rider.

The aspect of determining, tracking, and extracting pose data associated with a subject of interest is illustrated in FIG. 2 by the parenthetical inclusion of “pose” in operations 215, 220, and 225 to indicate that the pose data may be an included feature or possibly a selectively or optionally included feature.

At operation 230, the extracted data is presented in a user-understandable format.

In some embodiments, data extracted from a video sequence of a subject may be communicated or delivered to a viewer in one or more ways. For example, the extracted data may be generated and presented to a viewer during a live video broadcast or during a subsequent broadcast (215). In some instances, the extracted data may be provided concurrently with the broadcast of the video, on separate communications channel in a format that is the same or different than the video broadcast. In some embodiments, the broadcast embodiments of the extracted trajectory data presentation may include graphic overlays. In some embodiments, a path of motion for a subject of interest may be presented in one or more of a video graphics overlay. The graphics overlay may include a line, a pointer, or other indicia to indicate an association with the subject of interest. Text including one or more of an extracted statistic related to the trajectory of the subject may be displayed alone or in combination with the path of trajectory indicator. In some embodiments, the graphics overlay may be repeatedly updated over time as a video sequence changes to provide an indication of a past and a current path of motion (i.e., a track). In some embodiments, the graphics overlay is repeatedly updated and re-rendered so as not to obfuscate other objects in the video such as, for example, other objects in a foreground of the video.

In some embodiments, at least a portion of the extracted data may be used to revisualize the event(s) captured by the video. For example, in a sporting event environment, the players/competitors captured in the video may be represented as models based on the real world players/competitors and re-cast in a view, perspective, or effect that is the same as or different from the original video. One example may include presenting a video sequence of a sporting event from a view or angle not specifically captured in the video. This revisualization may be accomplished using computer vision techniques and processes, including those described herein, to represent the sporting event by computer generated model representations of the players/competitors and the field of play using, for example, the geometrical information of the image capturing system and knowledge of the playing field environment to revisualize the video sequence of action from a different angle (e.g., a virtual “blimp” view) or different perspective (e.g., a viewing perspective of another player, a coach, or fan in a particular section of the arena).

In some embodiments, data extracted from a video sequence may be supplied or otherwise presented to a system, device, service, service provider, or network so that a system, device, service, service provider, or network may use the extracted data to update an aspect of the service, system, device, service provider, network, or resource with the extracted data. For example, the extracted data may be provided to an online gaming network, service, service provider, or users of such online gaming networks, services, service providers to update to update aspects of an online gaming environment. An example may include updating player statistics for a football, baseball, or other type of sporting event or other activity so that the gaming experience may more closely reflect real-world conditions. In yet another example, the extracted data may be used to establish, update, and supplement a fantasy league related to real-word sports/competitions/activities.

In some embodiments, at least a portion of the extracted data may be presented for viewing or reception by a viewer or other user of the information via a network such as the Web or a wireless communication link interfaced with a computer, handheld computing device, mobile telecommunications device (e.g., mobile phone, personal digital assistant, smart phone, and other dedicated and multifunctional devices) including functionality for presenting one or more of video, graphics, text, and audio.

As illustrated at 125, 130, and 135 the extracted data may be provided to a number of destinations including, for example, a broadcast of the video to a mobile device 125, remote display device 130, and web devices 135. The processes disclosed herein are preferably sufficiently efficient and sophisticated to permit the extraction and presentation of motion data substantially in real time during a live broadcast of the captured video to either one or all of the destinations of FIG. 1.

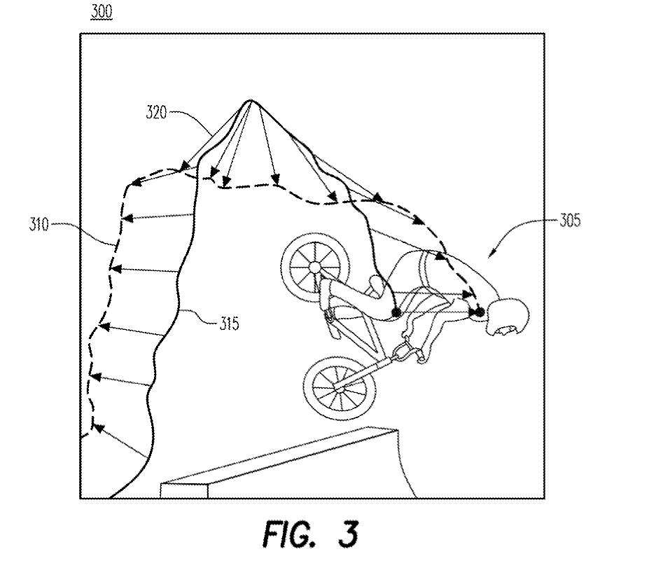

FIG. 3 is an exemplary illustration of an image 300, including graphic overlays representative of trajectory tracking, in accordance herewith. Image 300 includes an image from a video sequence of a bmx (bicycle moto-cross) event. In the course of a broadcast the captured image 300 may be processed in accordance with methods and processes herein extract the bmx rider 305 and produce a first track 310 and a second track 315 for rider 305. Track 310 may correspond to the trajectory of first jump by rider 305 and track 310 may correspond to the trajectory of a second jump by rider 305. Arrows 320 visually indicate difference between the first and second tracks 310 and 315, including a direction of the change as indicated by the direction of the arrow on the ends of lines 320.

The presentation of the two tracks 310 and 315 provide, in a readily and easily understood manner, an accurate visualization of the trajectory of the rider's trajectory on two different jumps. In this manner, a viewer may be presented with a visualization of factual data based on the actual performance captured in the video sequence, thereby enhancing the viewing pleasure and understanding of the viewer.

In some embodiments, tracks 310 and 315 may be represented by different colors, different indicators (e.g., dashed line, dotted line, solid line, circles, triangles, etc.), and different levels of transparency for the tracks. In some embodiments, one trajectory track may be displayed (not shown) and in some embodiments more than one track may be simultaneously displayed, as shown in FIG. 3.

The trajectory determining and tracking aspects herein may be applied to a wide variety of events captured in a video sequence, including for example, track and field events, diving, swimming, ice skating events, gymnastics, skateboarding events, motor cross events, team sports, and individual sports. Additionally, the processes herein may be used to track objects in contexts other than sports such as, for example, analysis of crime scene, chase, and surveillance video sequences.

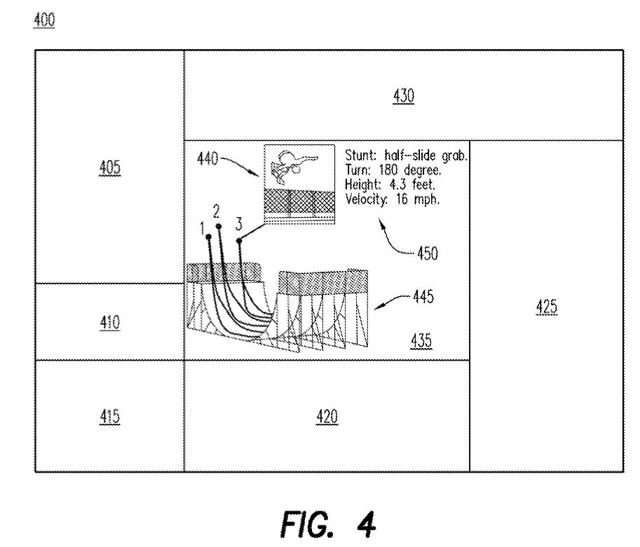

FIG. 4 is an exemplary depiction of a user interface or display screen 400 that includes a display window or pane of video captured, processed, and displayed in accordance with aspects herein. Display 400 may form part of a computer, a mobile device (e.g., mobile handset, PDA, media player, etc.), and a display device such as a television screen and a stadium display, scoreboard, or screen. Display 400 includes a number of panes 405, 410, 415, 420, 425, and 430 that may include various controls, graphics, and text. In some embodiments, display pane 435 may be expanded to occupy a greater or smaller percentage of screen 400 than that specifically depicted in FIG. 4.

Display pane 435 includes a presentation of a trajectory associated with a skateboarder captured in a video sequence. In particular, three trajectory tracks, labeled 1, 2, and 3, are shown in display pane 435. Tracks 1, 2, 3, may relate to three different “runs” by a single skateboarder or relate to “runs” by one, two, three, or more different skateboarders performing on ramp 445.

In some embodiments, telemetry data derived from trajectory data extracted from the captured video of the video sequence depicted in display 435 may be selectively provided for as shown at caption 450. The telemetry data presented in image 400 includes tracks 1, 2, and 3 (e.g., lines representing the path of travel for the associated player) and the descriptive caption 450 that includes an indication of the tracked skater's stunt, pose (I.e., turn: 180degrees), height, and velocity. It is noted that other or additional trajectory information associated with the skater may be presented such as, for example, a distance traveled, an impact point(s), a direction of an in-flight rotation. In some embodiments, an indication may be provided to indicate the distance, path, and location of the subject in three dimensions.

It should be noted that telemetry data for the subject may be determined and tracked, whether such information is presented in combination with a broadcast of the video or not. The determined and processed telemetry data may be presented in other forms, at other times, and to other destinations other than concurrently with a broadcast or other presentation of the vide sequence.

In some embodiments of the methods, processes, and systems herein, a plurality of efficient and sophisticated visual detection, tracking, and analysis techniques and processes may be used to effectuate the visual estimations herein. The visual detection, tracking, and analysis techniques and processes may provide results based on the use of a number of computational algorithms related to or adapted to vision-based video technologies.

While the disclosure has been described in detail in connection with only a limited number of embodiments, it should be readily understood that the disclosure is not limited to such disclosed embodiments. Rather, the disclosure embodiments may be modified to incorporate any number of variations, alterations, substitutions or equivalent arrangements not heretofore described, but which are commensurate with the spirit and scope of the invention. Accordingly, the disclosure is not to be seen as limited by the foregoing description.

What is claimed is:

1. A method comprising:
stabilizing a video sequence captured by an image capturing system;
extracting a subject of interest in the stabilized video sequence to isolate the subject from other objects in the video sequence;
determining a trajectory associated with the subject;
tracking the trajectory of the subject over a period of time;
extracting data associated with the trajectory of the subject based on the tracking; and
presenting the extracted data in a user-understandable format.

2. The method of claim 1, wherein the trajectory provides one of a two-dimensional (2-D) location of the subject and a three-dimensional (3-D) location of the subject.

3. The method of claim 1, wherein the extracting of the subject of interest in the stabilized video sequence is manually initialized by a user.

4. The method of claim 1, wherein the extracting of the subject of interest in the stabilized video sequence is automatically initialized by a machine.

5. The method of claim 1, further comprising determining a pose associated with the subject.

6. The method of claim 5, further comprising:
tracking the pose of the subject over a period of time; and
extracting data associated with the pose of the subject based on the tracking.

7. The method of claim 1, wherein the image capturing includes a plurality of image capture devices.

8. The method of claim 1, wherein the user-understandable format comprises at least one of an image, a video, graphics, a textual presentation, and an audio presentation.

9. The method of claim 1, wherein the presenting of the extracted data in a user-understandable format is provided in at least one of the following: in combination with a broadcast of the video sequence and in combination with a re-visualization of the video sequence.

10. The method of claim 9 wherein the re-visualization includes generating a model representation of at least the subject.

11. The method of claim 1, wherein the image capturing system captures the video sequence including the subject without a marker being located on the subject to aid the image capturing and the subject detecting.

12. A system, comprising:
image capturing system; and
a computing system connected to the image capturing system, the computing system adapted to:
stabilize a video sequence captured by an image capturing system;
extract a subject of interest in the stabilized video sequence to isolate the subject from other objects in the video sequence;
determine a trajectory associated with the subject;
track the trajectory of the subject over a period of time;
extract data associated with the trajectory of the subject based on the tracking; and
present the extracted data in a user-understandable format.

13. The system of claim 12, wherein the trajectory provides one of a two-dimensional (2-D) location of the subject and a three-dimensional (3-D) location of the subject.

14. The system of claim 12, wherein the extracting of the subject of interest in the stabilized video sequence is manually initialized by a user.

15. The system of claim 12, wherein the extracting of the subject of interest in the stabilized video sequence is automatically initialized by a machine.

16. The system of claim 12, wherein the processor is further adapted to determine a pose associated with the subject.

17. The system of claim 16, wherein the processor is further adapted to:
track the pose of the subject over a period of time; and
extract data associated with the pose of the subject based on the tracking.

18. The system of claim 12, wherein the image capturing includes a plurality of image capture devices.

19. The system of claim 12, wherein the user-understandable format comprises at least one of an image, a video, graphics, a textual presentation, and an audio presentation.

20. The system of claim 12, wherein the processor is further adapted to present the extracted data in the user-understandable format in at least on of the following: in combination with a broadcast of the video sequence and in combination with a re-visualization of the video sequence.

21. The system of claim 12, wherein the image capturing system captures the video sequence including the subject without a marker being located on the subject to aid the image capturing and the subject detecting.
